(19) United States
(12) Patent Application Publication
(10) Pub. No.: US 2008/0029476 A1
(43) Pub. Date: Feb. 7, 2008

(54) Circuit Board And Manufacturing Method Thereof

(76) Inventors: Tadahiro Ohmi, Sendai-shi (JP); Akihiro Morimoto, Sendai-shi (JP); Takeyoshi Kato, Tokyo (JP); Masafumi Kawasaki, Tokyo (JP); Yasuhiro Wakizaka, Tokyo (JP)

Correspondence Address: BIRCH STEWART KOLASCH & BIRCH, PO BOX 747, FALLS CHURCH, VA, 22040-0747, US

(21) Appl. No.: 10/594,599

(22) PCT Filed: Feb. 24, 2005
(86) PCT No.: PCT/JP05/03038

§ 371 Date: Feb. 8, 2007

(30) Foreign Application Priority Data
Mar. 31, 2004 (JP) 2004-108297

(51) Int. Cl. H01B 13/00

(52) U.S. Cl. 216/13; 205/125

(57) ABSTRACT

A circuit board having high adhessiveness contact between electrically insulating layers and having a low interlayer electric resistance is provided. A circuit board is provided with a first conductive layer formed on a core (1) and a first electrically insulating layer formed thereon. In the circuit board, a first conductor layer has a surface roughness Ra of 0.1 nm or more but less than 100 nm, and a first primer layer having a thiol compound as a main material is provided between the first conductive layer and the first electrically insulating layer. Thus, the circuit board which has excellent adhesiveness between the first conductor layer and the first electrically insulating layer and is also applicable to high frequency signal is provided.

### TECHNICAL FIELD

This invention relates to a circuit board and, more specifically, relates to a circuit board in which adhesion between a conductor layer and an electrically insulating layer or between electrically insulating layers is high and, further, noise of the conductor layer and crosstalk or radiation noise between adjacent conductors (wires) hardly mix with a high-frequency signal flowing in a circuit, an electronic device using the circuit board, and a manufacturing method of the circuit board. Herein, the conductor layer may be either a layer made of only a conductor or a layer including a circuit formed by a conductor.

### BACKGROUND ART

With electronic devices becoming smaller in size and more multifunctional, higher densification has been required also for circuit boards used in the electronic devices.

As a general technique for densification of a circuit board, it is well known to multilayer the circuit board. The multilayered circuit board is normally obtained by stacking a first electrically insulating layer on an inner-layer board having a first conductor layer formed on a core and then forming a second conductor layer on the first electrically insulating layer, and according to necessity, further stacking second and subsequent electrically insulating layers and third and subsequent conductor layers in several layers.

Conductor layers in a multilayered circuit board are normally insulated from each other by an electrically insulating layer, but there are also those portions connected by wiring, such as a via hole for energization between mutual circuits according to necessity.

When adhesion between a conductor layer and an electrically insulating layer or adhesion between electrically insulating layers is insufficient, there may be a case where a gap is generated between the conductor layer and the electrically insulating layer and, if vapor or the like enters the gap, the electrical insulating properties are reduced. Further, disconnection may also occur due to excessive load applied to a via hole.

In view of this, there is known a method that roughens a conductor layer on an inner-layer board to produce an anchor effect, thereby improving adhesion with an electrically insulating layer stacked thereon. In recent years, in order to achieve higher adhesion, it has been proposed to apply a roughening treatment to a conductor layer and form a primer layer of a thiol compound in Patent Document 1 or the like.

Patent Document 1 proposes a circuit board having an inner-layer board formed with a conductor layer on the surface of an electrically insulating layer, wherein a primer layer made of a thiol compound is formed on the conductor layer roughened to a surface roughness Ra of 0.1 to 5 μm and another electrically insulating layer made of a setting resin composition is provided on the primer layer. However, with the surface roughness of the conductor layer in this circuit board, it has been very difficult to transmit a noiseless signal in signal transmission in a high-frequency range.

Further, with the circuit board shown in Patent Document 1, not only is it very difficult to deal with a high-frequency signal, but, following the circuit board densification, it is difficult to provide high-quality signal current in the high-frequency range due to crosstalk or radiation noise between adjacent conductors (wires).

Patent Document 1:

Japanese Unexamined Patent Application Publication (JP-A) No. 2003-53879

### DISCLOSURE OF THE INVENTION

### Problem to be Solved by the Invention

Therefore, the technical subject of this invention is to provide a circuit board having high adhesion between a conductor layer with a low surface roughness and an electrically insulating layer and, further, adapted to suppress noise when a high-frequency signal flowing in a circuit is conducted, and crosstalk or radiation noise between adjacent conductors (wires).

### Means for Solving the Problem

In a circuit board having an electrically insulating layer on a roughened conductor layer, when the surface roughness of the conductor layer becomes equal to or greater than its skin depth in a high-frequency range, signal loss occurs due to the surface roughness. Therefore, in order to prevent the occurrence of the signal loss, the surface roughness is preferably set equal to or less than 1/10 of the skin depth.

According to one aspect of this invention, there is provided a circuit board having a first conductor layer formed on a core and a first electrically insulating layer formed on the first conductor layer, the circuit board characterized in that a surface roughness Ra of the first conductor layer is 0.1 nm or more and less than 100 nm and a first primer layer having a thiol compound (a) as a main material is formed between the first conductor layer and the first electrically insulating layer.

Further, according to another aspect of this invention, there is provided an electronic device comprising a circuit board, the electronic device characterized in that the circuit board comprises a first conductor layer formed on a core and a first electrically insulating layer formed on the first conductor layer, a surface roughness Ra of the first conductor layer is 0.1 nm or more and less than 100 nm, and a first primer layer having a thiol compound (a) as a main material is formed between the first conductor layer and the first electrically insulating layer.

Further, according to still another aspect of this invention, there is provided a method of manufacturing a circuit board which comprises the steps of forming a first conductor layer on a core, then bringing the board surface formed with the first conductor layer into contact with a metal corrosive agent to form the first conductor layer having a surface roughness Ra of 0.1 nm or more and less than 100 nm, then bringing a primer composition containing a thiol compound (a) into contact with the board surface formed with the first conductor layer to form a first primer layer, then stacking on the first primer layer an uncured or semicured resin mold made of a curable resin composition, and then curing the resin mold to form a first electrically insulating layer.

### Effect of the Invention

According to this invention, it is possible to provide a circuit board having high adhesion between a conductor layer with a low surface roughness and an electrically insulating layer and, further, adapted to suppress noise when high-frequency signal flowing in a circuit is conducted, and crosstalk or radiation noise between adjacent conductors (wires).

### BRIEF DESCRIPTION OF THE DRAWINGS

FIG. 1 is a sectional view showing one structural example of a circuit board according to this invention.

### DESCRIPTION OF SYMBOLS

1 core
2 first conductor layer
3 first electrically insulating layer
4 second conductor layer
5 second electrically insulating layer
100 circuit board

### BEST MODE FOR CARRYING OUT THE INVENTION

This invention will be further described in detail.

A circuit board of this invention is configured such that a first conductor layer is formed on a core and a first electrically insulating layer is formed on the first conductor layer. The surface roughness Ra of the first conductor layer is 0.1 nm or more and less than 100 nm, and a first primer layer having a thiol compound (a) as a main material is formed between the first conductor layer and the first electrically insulating layer. Herein, in the circuit board, it is preferable that the surface roughness Ra of the first electrically insulating layer is 0.1 nm or more and 400 nm or less.

Further, in the circuit board, it is preferable that a second conductor layer, a second primer layer having a thiol compound (b) as a main material, and a second electrically insulating layer is stacked on the first electrically insulating layer in the order described.

Further, in the circuit board, it is preferable that the surface roughness Ra of the second conductor layer is 0.1 nm to 1 μm. When another electrically insulating layer or another conductor layer is further formed on the second conductor layer, it is desirable that, like the first conductor layer, the surface roughness Ra of the second conductor layer is 0.1 nm or more and less than 100 nm.

Further, in the circuit board, it is preferable that the surface roughness Ra of the second electrically insulating layer is 0.1 nm or more and 400 nm or less.

Then, in any one of the foregoing circuit boards, it is preferable that the thiol compounds (a) and (b) of the first and second primer layers each is a compound expressed by the following formula (1) or (2) or an alkali metal salt thereof.

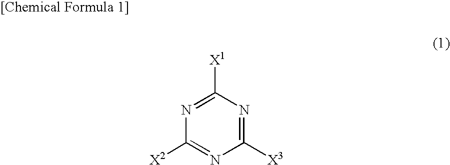

(in formula (1), X¹ to X³ are, independently of each other, —SH, —SR—NR′R″, or —SM (R, R′, and R″ are, independently of each other, linear or branched alkyl groups each having a carbon number of 1 to 5 and M is an alkali metal) and at least one of them is —SH)

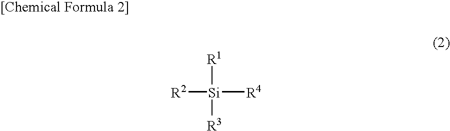

(in formula (2), R¹ to R⁴ are, independently of each other, linear or branched alkyl groups each having a carbon number of 1 to 5 and each having one or more —OR (R is a linear or branched alkyl group having a carbon number of 1 to 5) or —SH and at least one of them is a linear or branched alkyl group having a carbon number of 1 to 5 and having one or more —SH)

Further, in any one of the foregoing circuit boards, it is preferable that the thiol compounds (a) and (b) of the first and second primer layers each is a compound expressed by the foregoing formula (1) and X¹ to X³ in the foregoing formula (1) be all —SH.

Further, in the foregoing circuit board, it is preferable that the first electrically insulating layer is formed by curing a curable resin composition containing an alicyclic olefin polymer.

Further, in the foregoing circuit board, it is preferable that the second electrically insulating layer is formed by curing a curable resin composition containing an alicyclic olefin polymer.

Further, in the foregoing circuit board, given that the relative permittivity and the relative magnetic permeability of the first electrically insulating layer are εr and μr, respectively, it is preferable that at least part of the first electrically insulating layer satisfies a relationship of εr≦μr.

On the other hand, in the foregoing circuit board, given that the relative permittivity and the relative magnetic permeability of the second electrically insulating layer are εr and μr, respectively, it is preferable that at least part of the second electrically insulating layer satisfies a relationship of εr≦μr.

An electronic device of this invention has any one of the foregoing circuit boards.

Further, a circuit board manufacturing method of this invention is a method of obtaining a circuit board by forming a first conductor layer on a core, then bringing the board surface formed with the first conductor layer into contact with a metal corrosive agent to form the first conductor layer having a surface roughness Ra of 0.1 nm or more and less than 100 nm, then bringing a primer composition containing a thiol compound (a) into contact with the board surface formed with the first conductor layer to form a first primer layer, then stacking on the first primer layer an uncured or semicured resin mold made of a curable resin composition, and then curing the resin mold to form a first electrically insulating layer.

In the foregoing circuit board manufacturing method, it is preferable to include a process of bringing the surface of the first electrically insulating layer into contact with an oxidizing compound to adjust a surface roughness Ra to 0.1 nm or more and 400 nm or less.

Further, a circuit board manufacturing method to this invention is either of the foregoing circuit board manufacturing methods and is a method of obtaining a circuit board by forming a second conductor layer on the first electrically insulating layer having the surface roughness of 0.1 nm or more and 400 nm or less, then bringing a primer composition containing a thiol compound (b) into contact with the board surface formed with the second conductor layer to form a second primer layer, then stacking on the second primer layer a film-shaped mold made of a curable resin composition, and then curing the film-shaped mold to form a second electrically insulating layer.

As described before, it is preferable that the surface roughness Ra of the first and second conductor layers is 0.1 nm or more and less than 100 nm. This is because if the surface roughness Ra of each conductor layer becomes 100 nm or more, signal loss due to the surface roughness occurs, while, if it becomes less than 0.1 nm, adhesion with the electrically insulating layer decreases.

Further, it is preferable that the surface roughness Ra of each electrically insulating layer is 0.1 nm or more and 400 nm or less. This is because if the surface roughness of the electrically insulating layers exceeds 400 nm, it becomes difficult to form fine patterns on the conductor layers, while, if it becomes less than 0.1 nm, when the electrically insulating layers are stacked and cured, there is a possibility that, for example, adhesion between the first and second electrically insulating layers cannot be ensured.

A circuit board of this invention has a structure in which a primer layer and an electrically insulating layer are stacked on one side or each of both sides of an inner-layer board having an electrically insulating layer and a conductor layer stacked and may be a multilayered circuit board in which a plurality of electrically insulating layers and a plurality of conductor layers are stacked.

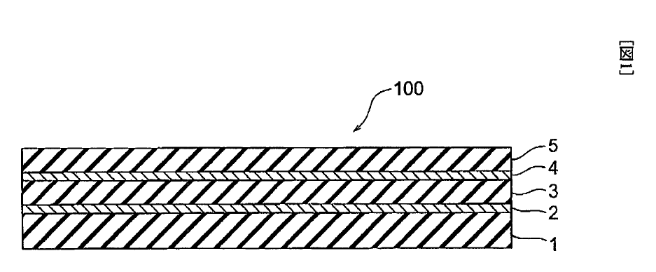

Referring to FIG. 1, this invention will be described in further detail.

Referring to FIG. 1, an inner-layer board 100 used in this invention is such that a first conductor layer 2 whose surface roughness Ra is adjusted to 0.1 nm or more and less than 100 nm is formed on the surface of a core 1 in the form of an electrically insulating layer and a first electrically insulating layer 3 is formed on the first conductor layer 2. Further, thereon, a second conductor layer 4 whose surface roughness Ra is adjusted to 0.1 nm to 1 μm is formed and, thereon, a second electrically insulating layer 5 is formed. The second conductor layer 4 and the second electrically insulating layer 5 may be omitted, while, second conductor layers 4 and second electrically insulating layers 5 may be repeatedly stacked, thereby forming a multilayer structure. In the case of the multilayer structure, it is preferable that, the surface roughness Ra of the second conductor layer 4 is 0.1 nm or more and less than 100 nm similarly to the first conductor layer 2. Herein, non-illustrated primer layers are formed between the first and second conductor layers 2 and 4 and the first and second electrically insulating layers 3 and 5, respectively.

The first electrically insulating layer 3 relating to this invention is formed by curing a curable resin composition containing a known electrically insulating material (e.g. alicyclic olefin polymer, epoxy resin, maleimide resin, (meth)acrylic resin, diallyl phthalate resin, triazine resin, polyphenyl ether, glass, or the like). Naturally, the first electrically insulating layer 3 accoding to this invention may be the second electrically insulating layer 5 as an outermost-surface electrically insulating layer of a circuit board having electrically insulating layers and conductor layers. In this invention, a layer formed by curing a later-described curable resin composition containing an alicyclic olefin polymer is preferable as the interlayer first electrically insulating layer 3. The surface of the first electrically insulating layer 3 may be brought into contact with an oxidizing compound or a plasma, thereby enhancing adhesion between the electrically insulating layers.

The first and second conductor layers 2 and 4 formed on the surfaces of the core 1 and the first electrically insulating layer 3 are each an electrical circuit formed by a conductor, such as a conductive metal and, as its circuit structure and so on, use can be made of those that are used in a normal multilayered circuit board. Particularly in this invention, very high adhesion is exhibited when the conductive metal is copper.

As a method of forming the first or second conductor layer 2 or 4 on the surface of the core or the first electrically insulating layer 3, a method by plating or sputtering may be exemplified and, in terms of productivity, the method by plating is preferable.

The surface roughness Ra of the first conductor layer 2 relating to this invention is 0.1 nm or more and less than 100 nm, preferably 1 nm to 95 nm, and more preferably 40 nm to 90 nm, and the surface roughness Ra of the second conductor layer 4 is 0.1 nm to 1 μm and preferably 0.1 nm or more and less than 100 nm. When Ra falls within this range, high adhesion with the electrically insulating layer is obtained. Herein, the surface roughness Ra is a value defined by JIS B0601-1994.

As a method of adjusting the first or second conductor layer 2 or 4 to the foregoing range of surface roughness Ra, a roughening method may be exemplified that brings the board into contact with a metal corrosive agent containing, as an effective component, an inorganic peracid alkali salt, such as sodium perchlorate or sodium persulfate, an inorganic acid, such as sulfuric acid or hydrochloric acid, an organic acid, such as formic acid, acrylic acid, oxalic acid, or citric acid, or the like. Particularly, when the inorganic acid is used, it is easy to obtain the surface roughness Ra in the foregoing range, which is thus preferable.

The concentration of the effective component in the metal corrosive agent is normally 0.1 to 20 wt % and preferably 0.1 to 10 wt %. The treatment temperature can be optionally set in consideration of a boiling point of the metal corrosive agent and is normally 25 to 120° C. and preferably 50 to 100° C. The treatment time is several seconds to 60 minutes and more preferably several seconds to 30 minutes.

As a specific example of the inner-layer board having the electrically insulating layers and the conductor layers as described above, use may be made of a printed wiring board, a silicon wafer board, or the like. The thickness of the inner-layer board is normally 10 μm to 2 mm, preferably 25 μm to 1.6 mm, and more preferably 40 m to 1 mm.

The foregoing primer layers formed on the surfaces of the inner-layer board have thiol compounds (a) and (b) as main materials, respectively.

Hereinbelow, the thiol compound (a) and the thiol compound (b) will be collectively described as a “thiol compound”. Note that the thiol compound (a) and the thiol compound (b) may be the same as or different from each other.

The thiol compound used in this invention is a compound having a —SH group.

As specific examples of preferable thiol compounds, use may be made of triazine thiol compounds, such as 2,4,6-trimercapto-s-triazine, expressed by formula (1) and their alkali metal salts, and alkyl group bonded silane compounds each having a mercapto group, such as y-mercaptopropyltrimethoxysilane, expressed by formula (2) and their derivatives.

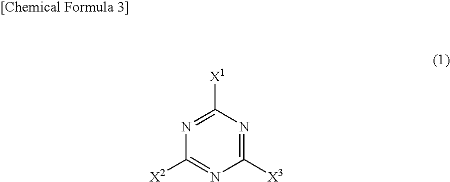

(in formula (1), X¹ to X³ are, independently of each other, —SH, —SR—NR′R″, or —SM (R, R′, and R″ are, independently of each other, linear or branched alkyl groups each having a carbon number of 1 to 5 and M is an alkali metal) and at least one of them is —SH)

Among triazine thiol compounds expressed by the foregoing formula (1) and their derivatives, use is preferably made of a compound having two or three —SH groups and more preferably a compound having three —SH groups in terms of capability of obtaining particularly high adhesion.

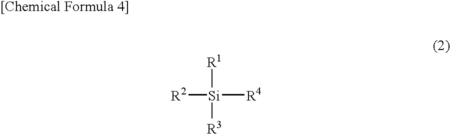

(in formula (2), R¹ to R⁴ are, independently of each other, linear or branched alkyl groups each having a carbon number of 1 to 5 and each having one or more —OR (R is a linear or branched alkyl group having a carbon number of 1 to 5) or —SH and at least one of them is a linear or branched alkyl group having a carbon number of 1 to 5 and having one or more —SH)

Among alkyl group bonded silane compounds expressed by the foregoing formula (2) and their derivatives, mercaptoalkyltrialkoxysilane is preferable in terms of particularly excellent balance between adhesion and operability.

For forming the primer layer on the surface of the inner-layer board, the thiol compound and the inner-layer board are brought into contact with each other. A contacting method is not particularly limited. As a specific example, use may be made of a dip method of dissolving the thiol compound into water or an organic solvent to obtain a solution and then dipping the inner-layer board in this solution for approximately several seconds to several minutes, a spray method of coating this solution on the surface of the inner-layer board by spraying, or the like. After contacting the thiol compound and the inner-layer board with each other, drying is applied thereto. A drying method is not particularly limited. For example, there is cited a method of drying in an oven at a drying temperature of normally 30 to 180° C., preferably 50 to 150° C., for a drying time of normally 1 minute or more, preferably 5 to 120 minutes. Particularly, when the conductor layer is a metal, such as copper, drying is preferably carried out under a nitrogen atmosphere in terms of antioxidation.

The organic solvent for dissolving the thiol compound is not particularly limited, but is preferably a polar solvent like ether, such as tetrahydrofuran, alcohol, such as ethanol or isopropanol, ketone, such as acetone, or cellosolve, such as ethyl cellosolve acetate. The thiol compound concentration in the thiol compound solution is not particularly limited, but is normally 0.01 to 30 wt % and preferably 0.05 to 20 wt %.

In this invention, the primer layer contains the foregoing thiol compound as a main material and, as components other than the thiol compound in the thiol compound solution used in forming the primer layer, use may be made of a surfactant for use in the purpose of improving wetting between the inner-layer board and the thiol compound, and other additives. In terms of ensuring adhesion, the amount of use of these additives is 10 wt % or less, preferably 5 wt % or less, and more preferably 1 wt % or less relative to the thiol compound.

No particular limitation is made to a material forming the first electrically insulating layer 3 and the second electrically insulating layer 5. As the material, a general electrically insulating material can be used. As a preferable electrically insulating material, use may be made of a curable resin composition containing an insulating polymer (hereinafter may be simply referred to as a “curable resin composition”) and, particularly, an alicyclic olefin polymer is preferably used as the insulating polymer. By forming the curable resin composition into a predetermined shape and curing it, the electrically insulating layer is formed.

The insulating polymer is a polymer having electrically insulating properties, such as an epoxy resin, a maleimide resin, a (meth)acrylic resin, a diallyl phthalate resin, a triazine resin, an alicyclic olefin polymer, an aromatic polyether polymer, a benzocyclobutene polymer, a cyanate ester polymer, a liquid crystal polymer, or a polyimide. Among them, the alicyclic olefin polymer, the aromatic polyether polymer, the benzocyclobutene polymer, the cyanate ester polymer, or the polyimide is preferable, the alicyclic olefin polymer or the aromatic polyether polymer is particularly preferable, and the alicyclic olefin polymer is most preferable. The alicyclic olefin polymer preferably has a polar group. As the polar group, use may be made of a hydroxyl group, a carboxyl group, an alkoxyl group, an epoxy group, a glycidyl group, an oxycarbonyl group, a carbonyl group, an amino group, an ester group, a carboxylic acid anhydride group, or the like. Particularly, the carboxyl group or the carboxylic acid anhydride group is preferable.

As the alicyclic olefin polymer, use may be made of a ring-opening polymer of a monomer having a norbornene ring (hereinafter referred to as a “norbornene-based monomer”), such as 8-ethyl-tetracyclo[4.4.0.1^{2.5}.1^{7.10}]dodeca-3-ene, or its hydrogenated product, an addition polymer of a norbornene-based monomer, an addition polymer of a norbornene-based monomer and a vinyl compound, a monocyclic cycloalkene polymer, an alicyclic conjugated diene polymer, a vinyl-based alicyclic hydrocarbon polymer or its hydrogenated product, an aromatic ring hydrogenated product of an aromatic olefin polymer, or the like. Among them, the ring-opening polymer of the norbomene-based monomer or its hydrogenated product, the addition polymer of the norbornene-based monomer, the addition polymer of the norbornene-based monomer and the vinyl compound, or the aromatic ring hydrogenated product of the aromatic olefin polymer is preferable and, particularly, the hydrogenated product of the ring-opening polymer of the norbomene-based monomer is preferable. No particular limitation is made to an alicyclic olefin or aromatic olefin polymerization method or a method of hydrogenation which is carried out where necessary, and these can be implemented according to known methods.

As a curing agent, use can be made of a general curing agent, such as an ionic curing agent, a radical curing agent, or a combined ionic and radical curing agent and, particularly, a polyfunctional epoxy compound, such as a glycidyl ether type epoxy compound like bisphenol A bis(propylene glycol glycidyl ether)ether, an alicyclic epoxy compound, or a glycidyl ester type epoxy compound is preferable. Other than the epoxy compound, use can be made of a non-epoxy-based curing agent having a carbon-carbon double bond to contribute to crosslinking reaction, such as 1,3-diallyl-5-[2-hydroxy-3-phenyloxypropyl]isocyanurate.

The mixing ratio of the curing agent is in the range of normally 1 to 100 weight parts, preferably 5 to 80 weight parts, and more preferably 10 to 50 weight parts relative to 100 weight parts of the insulating polymer.

Further, when the polyfunctional epoxy compound is used as the curing agent, it is preferable to use a curing accelerator or a curing assistant, such as a tertiary amine compound (1-benzyl-2-phenylimidazole or the like) or a boron trifluoride complex compound in order to accelerate the curing reaction. The content of the curing accelerator or the curing assistant is normally 0.001 to 30 weight parts, preferably 0.01 to 10 weight parts, and more preferably 0.03 to 5 weight parts relative to 100 weight parts of the insulating polymer.

The mixing amounts of the curing agent and the curing accelerator or the curing assistant are properly selected according to the purpose of use.

Further, it is possible to mix a magnetic substance into the curable resin composition. It is preferable that the magnetic substance have electrically insulating properties and it is particularly preferable that the magnetic substance provide εr≦μr (εr represents a relative permittivity and μr a relative magnetic permeability) of the electrically insulating layer. As a particularly preferable magnetic substance, there is cited powder of an insulating magnetic substance, such as ferrite, or a simple substance of a metal magnetic element, such as Fe, Co, Ni, or Cr or an alloy thereof.

Regardless of the structure of an electrically insulating layer surrounding a conductor layer, the relative permittivity εr and the relative magnetic permeability μr of the electrically insulating layer are evaluated by an effective permittivity and an effective magnetic permeability that affect an electromagnetic wave propagating in the conductor. As a method of measuring the effective permittivity or the effective magnetic permeability, it is possible to use a triplate-line resonator method or the like that determines the permittivity or the magnetic permeability by actually measuring an electromagnetic wave propagating in wiring.

The mixing amount of the magnetic substance is normally 1/10⁶ to 300 weight parts and preferably 1/10³ to 200 weight parts relative to 100 weight parts of the alicyclic olefin polymer. If the content ratio of the magnetic substance is too small, the existing amount of the magnetic substance in the electrically insulating layer is reduced, thus resulting in less effect of increasing the magnetic permeability of the electrically insulating layer, while, if it is too high, the manufacture becomes difficult because uniform dispersion is not obtained.

The curable resin composition normally contains a solvent, for example, an aromatic hydrocarbon-based solvent, such as toluene, xylene, ethylbenzene, or trimethylbenzene; an aliphatic hydrocarbon-based solvent, such as n-pentane, n-hexane, or n-heptane; an alicyclic hydrocarbon-based solvent, such as cyclopentane or cyclohexane; a halogenated hydrocarbon-based solvent, such as chlorobenzene, dichlorobenzene, or trichlorobenzene; or a ketone-based solvent, such as methylethylketone, methylisobutylketone, cyclopentanone, or cyclohexanone. These solvents can be used alone or in combination of two or more kinds.

Among these solvents, a mixed solvent in the mixture of the nonpolar solvent like the aromatic hydrocarbon-based solvent or the alicyclic hydrocarbon-based solvent and the polar solvent like the ketone-based solvent is preferable as a solvent that is excellent in embeddability into fine wiring and does not generate bubbles or the like. The mixing ratio of these nonpolar solvent and polar solvent can be properly selected.

The amount of use of the solvent is properly selected according to a purpose, such as thickness control or improvement in flatness, but is in a range where the solid matter concentration in a solution or a dispersion liquid of the curable resin composition is normally 5 to 70 wt %, preferably 10 to 65 wt %, and more preferably 20 to 60 wt %.

In addition to the respective components as described above, it is possible to mix an optional component, such as a soft polymer, a thermal stabilizer, a climatic stabilizer, an antioxidant, a leveling agent, an antistatic agent, a slip agent, an anti-blocking agent, an anti-fogging agent, a lubricant, a dye, a pigment, a natural oil, a synthetic oil, a wax, an emulsion, a filler, a dielectric property adjusting agent, or a toughening agent. The mixing amount of the optional component is properly selected within a range that does not impede the object of this invention.

As methods of forming an electrically insulating layer for a circuit board, there are three methods, i.e. (a) stacking on an inner-layer board (a board with a structure having a conductor layer on one side or each of both sides of a core) a film or a sheet being an uncured or semicured resin mold prepared in advance using the foregoing curable resin composition, and then curing it, (b) directly coating the curable resin composition on the conductor layer of the inner-layer board, drying it, and then curing it, and (c) stacking on the inner-layer board a sheet obtained by impregnating the curable resin composition into a sheet-shaped support made of glass fiber and drying it, and then curing the sheet. Among them, the method (a) is preferable in terms of easiness to obtain the smooth surface and easiness to form high-density wiring.

“uncured” of the uncured or semicured resin mold used in the method (a) represents a state where the alicyclic olefin polymer is substantially entirely dissolved in an alicyclic olefin polymer-soluble solvent. On the other hand, “semicured” represents a state where the resin mold is cured halfway to an extent that it is further curable by heating, preferably a state where the alicyclic olefin polymer is partially (specifically 7 wt % or more) dissolved in an alicyclic olefin polymer-soluble solvent or a state where the swelling ratio after immersion of the resin mold in the solvent for 24 hours is 200% or more of the volume before the immersion.

The film or sheet being the uncured or semicured resin mold may be obtained by an ordinary method and there is cited a method that coats the curable resin composition on a support, such as a resin film or a metal foil by a cast method using dip coating, roll coating, curtain coating, die coating, slit coating, or the like, and then dries it, thereby obtaining the resin mold.

The thickness of the film or sheet being the uncured or semicured resin mold is normally 0.1 to 150 μm, preferably 0.5 to 100 μm, and more preferably 1 to 80 μm.

Normally, when manufacturing a multilayered circuit board by the use of the forgoing layered product, a via hole that penetrates the layered product is first provided for connecting together respective conductor layers in the layered product. This via hole can be formed by a chemical treatment, such as a photolithography method, a physical treatment, such as drilling, laser, plasma etching, or the like. Among them, the method by the laser (carbon dioxide laser, excimer laser, UV-YAG laser, or the like) is preferable because a fine via hole can be formed without lowering the properties of the electrically insulating layer.

Then, in order to increase adhesiveness with the conductor layer, the surface of the electrically insulating layer is oxidized to be roughened so as to be adjusted to a desired surface roughness. In this invention, the surface roughness Ra of the electrically insulating layer is 0.1 nm or more and less than 400 nm, preferably 1 nm or more and 300 nm or less, and more preferably 10 to 200 nm. Herein, Ra is an arithmetic average roughness shown in JIS B 0601-1994.

For oxidizing the surface of the electrically insulating layer, the surface of the electrically insulating layer and an oxidizing compound are brought into contact with each other. As the oxidizing compound, there is cited a known compound having oxidizing power, such as an inorganic peroxide, an organic peroxide, or a gas. Particularly, in terms of easiness to control the surface roughness of the electrically insulating layer, it is preferable to use the inorganic peroxide or the organic peroxide.

As the inorganic peroxide, use may be made of permanganate, chromic anhydride, bichromate, chromate, persulfate, active manganese dioxide, osmium tetraoxide, hydrogen peroxide, periodate, ozone, or the like. As the organic peroxide, use may be made of dicumyl peroxide, octanoyl peroxide, m-chloroperbenzoic acid, peracetic acid, or the like.

When oxidizing the surface of the electrically insulating layer with a solution of the oxidizing compound, if a polymer (liquid epoxy resin or the like) or an inorganic filler (calcium carbonate, silica, or the like) soluble in the solution of the oxidizing compound is contained in the curable resin composition before being formed into the electrically insulating layer, it forms a fine sea-island structure along with the alicyclic olefin polymer and then is selectively dissolved and hence the surface average roughness is easily controlled within the foregoing range, which is thus preferable.

The polymer or the inorganic filler soluble in the solution of the oxidizing compound as described above can be used as part of a flame retardant, a thermal stabilizer, a dielectric property adjusting agent, a toughening agent, or the like optionally added to the curable resin composition of this invention.

After the oxidation process of the electrically insulating layer, the surface of the electrically insulating layer is normally washed with water so as to remove the oxidizing compound. When a substance that cannot be washed away only with the water is adhered, the substance may be further washed with a washing solution that can dissolve the substance, or may be converted to a water-soluble substance by contacting it with another compound and then washed with water. For example, in the case where the electrically insulating layer is brought into contact with an alkaline aqueous solution, such as a potassium permanganate aqueous solution or a sodium permanganate aqueous solution, a neutralization reduction process is carried out with an acidic aqueous solution, such as a mixed liquid of hydroxyamine sulfate and sulfuric acid for the purpose of removing a produced manganese dioxide film.

After-oxidizing the electrically insulating layer to adjust the surface roughness, the layered product is formed with a conductor layer on the surface of the electrically insulating layer and the inner wall surface of the via hole by plating or the like. No particular limitation is made to a method of forming the conductor layer, but, for example, a method can be used that forms a metal thin film on the electrically insulating layer by plating or the like and then grows the metal layer by thickening plating.

When the formation of the metal thin film is carried out by electroless plating, it is general to adhere catalyst nuclei of silver, palladium, zinc, cobalt, or the like on the electrically insulating layer before forming the metal thin film on the surface of the electrically insulating layer.

As an electroless plating solution for use in the electroless plating method, a known autocatalytic electroless plating solution may be used and there is no particular limitation to a kind of metal, a kind of reducing agent, a kind of complexing agent, a hydrogen ion concentration, a dissolved oxygen concentration, and so on contained in the plating solution. For example, use can be made of an electroless plating solution, such as an electroless copper plating solution containing, as a reducing agent, ammonium hypophosphite, hypophosphorous acid, hydrogenated boron ammonium, hydrazine, formalin, or the like; an electroless nickel-phosphorus plating solution containing sodium hypophosphite as a reducing agent; an electroless nickel-boron plating solution containing dimethylamineborane as a reducing agent; an electroless palladium plating solution; an electroless palladium-phosphorus plating solution containing sodium hypophosphite as a reducing agent; an electroless gold plating solution; an electroless silver plating solution; or an electroless nickel-cobalt-phosphorus plating solution containing sodium hypophosphite as a reducing agent.

After the formation of the metal thin film, a rust prevention process may be carried out by contacting the board surface with an antirust agent.

In the manner as described above, the metal thin film is formed on the surface of the electrically insulating layer, the side surfaces of the inner-layer board, and the inner wall surface of the via hole by the electroless plating method. Then, normally, the thickening plating is carried out on the metal thin film on the electrically insulating layer. As the thickening plating, for example, a resist pattern for plating is formed on the metal thin film according to an ordinary method, then the plating is grown thereon by wet plating, such as electrolytic plating, then the resist is removed, and then the metal thin film is etched into a pattern, thereby forming a conductor layer. Therefore, according to this method, the conductor layer is normally composed of the patterned metal thin film and the plating grown thereon.

After the formation of the metal thin film or after the thickening plating, the metal thin film can be heated for improving adhesion and so on. The heating temperature is normally 50 to 350° C. and preferably 80 to 250° C. The heating may be carried out under a pressurized condition and, as a method of pressurization in this event, there is cited, for example, a physical pressurization method by the use of a heat press machine, a pressurization heating roll machine, or the like. The pressure to be applied is normally 0.1 to 20 MPa and preferably 0.5 to 10 MPa. Within this range, high adhesion between the metal thin film and the electrically insulating layer can be ensured.

Using the multilayered circuit board thus obtained as the inner-layer board, for example, by sticking the foregoing uncured or semicured resin mold to the uppermost and lowermost two conductor layers of the inner-layer board formed with the primer layers and repeating the foregoing respective processes of curing, roughening, plating, and etching, further multilayering is enabled.

Further, in the foregoing circuit board, part of the conductor layers may serve as a metal power supply layer, a metal ground layer, or a metal shield layer.

The circuit board of this invention can be used as a printed wiring board for mounting semiconductor elements, such as a CPU and a memory and other mounting components in an electronic device, such as a computer or a portable telephone. Particularly, the circuit board having fine wiring is suitable as a high-density printed wiring board of a high-speed computer or a portable terminal for use in a high-frequency range.

Hereinbelow, this invention will be described in detail by citing Examples and Comparative Examples. In these Examples, parts and % are based on mass unless otherwise defined.

(1) Molecular Weight (Weight Average Molecular Weight Mw, Number Average Molecular Weight Mn)

Measured as a polystyrene-converted value by the gel permeation chromatography (GPC) using toluene as a solvent.

(2) Hydrogenation Ratio and Maleic Anhydride Content Ratio

The hydrogenation ratio with respect to the mole number of unsaturated bonds in a polymer before the hydrogenation and the ratio of the mole number of maleic anhydride residues (maleic anhydride residue content ratio) with respect to the total monomer unit number in the polymer were measured by the ¹H-NMR spectrum.

(3) Glass Transition Temperature (Tg)

Measured by the differential scanning calorimetry method (DSC method).

(4) Surface Roughness (Ra)

The surface roughness Ra was evaluated such that measurement was carried out at 5 portions with respect to a rectangular region of 20 μm×20 μm by the use of a non-contact type optical surface shape measuring apparatus (Keyence Corporation, Color Laser Microscope VK-8500) and the average thereof was derived as the surface roughness Ra of an electrically insulating layer or a conductor layer.

(5) TDR (Pulse Reflection Characteristics) Evaluation

In a multilayered circuit board multilayered with a first conductor layer 2, a first electrically insulating layer 3, a second conductor layer 4, and a second electrically insulating layer 5 formed in the order named on each of both sides of a core board 1, the first and second conductor layers 2 and 4 on each side were formed with microstrip wiring patterns defined by JPCA-BU01-5·5(2). In this event, the signal line width was set to 73 μm, the signal line thickness to 18 μm, the signal line length to 150 mm, and the thickness of the first electrically insulating layer 3 to 40 μm (characteristic impedance ZO=50Ω: designed). TDR (Time Domain Reflectmetry) evaluation was carried out for this evaluation board. One with an absolute value of [(measured value)-(designed value)] being less than 1Ω was evaluated as ⊚, one with an absolute value thereof being less than 5Ω was evaluated as ◯, one with an absolute value thereof being 5Ω or more and less than 10Ω was evaluated as Δ, and one with an absolute value thereof being 10Ω or more was evaluated as X.

(6) TDT (Pulse Transmission Characteristics) Evaluation

In a multilayered circuit board multilayered with a first conductor layer 2, a first electrically insulating layer 3, a second conductor layer 4, and a second electrically insulating layer 5 formed in the order named on each of both sides of a core board 1, the first and second conductor layers 2 and 4 on each side were formed with microstrip wiring patterns defined by JPCA-BU01-5·5(2). In this event, the signal line width was set to 73 μm, the signal line thickness to 18 μm, the signal line length to 150 mm, and the thickness of the first electrically insulating layer 3 to 40 μm (characteristic impedance ZO=50Ω: designed). TDT (pulse transmission characteristics) evaluation was carried out for this evaluation board by the use of Agilent 86100C (manufactured by Agilent Technology Corporation). Measurement was carried out given an input signal being 35 psec and n=10. Given that the average time required for the signal to rise from 10% to 90% was T₀ and each measurement time was t, one with a value calculated by the following formula 1 being less than ±1.0% was evaluated as ⊚, one with a value calculated thereby being ±1.0% or more and less than ±2.0% was evaluated as ◯, one with a value calculated thereby being ±2.0% or more and less than ±5.0% was evaluated as Δ, and one with a value calculated thereby being ±5.0% or more was evaluated as X.

[(T₀-t)/T₀]×100 (unit: %) (1)

### EXAMPLE 1

8-ethyl-tetracyclo[4.4.0.1 ^{2.5}.1^{7.10}]-dodeca-3-ene was ring-opening polymerized and then hydrogenated, thereby obtaining a hydrogenated polymer with number average molecular weight (Mn)=31,200, weight average molecular weight (Mw)=55,800, and Tg=approximately 140° C. The hydrogenation ratio of the obtained hydrogenated polymer was 99% or more.

100 parts of this hydrogenated polymer, 40 parts of maleic anhydride, and 5 parts of dicumyl peroxide were dissolved in 250 parts of t-butylbenzene and the reaction was carried out at 140° C. for 6 hours. An obtained reaction product solution was poured into 1000 parts of isopropyl alcohol to solidify the reaction product and the obtained solid matter was vacuum-dried at 100° C. for 20 hours, thereby obtaining a maleic acid modified hydrogenated polymer. This maleic acid modified hydrogenated polymer had Mn=33,200, Mw=68,300, and Tg=170° C. The maleic anhydride residue content ratio was 25 mol %.

100 parts of the obtained maleic acid modified hydrogenated polymer, 40 parts of bisphenol A bis(propylene glycol glycidyl etherether, 0.1 parts of 1-benzyl-2-phenylimidazole (curing accelerator), 5 parts of 2-[2-hydroxy-3,5-bis(α, α-dimethylbenzyl)phenyl]benzotriazole (laser tris(3,5-di-t-butyl-4-hydroxybenzyl)-isocyanurate, and 10 parts of liquid polybutadiene (B-1000, Nippon Petrochemicals Company, Ltd.) were dissolved in a mixed organic solvent composed of 222 parts of xylene and 55.5 parts of cyclopentanone, and mixed by a planetary mixer (manufactured by Kurabo Industries Ltd.), thereby obtaining a varnish.

The obtained varnish was coated on polyethylene naphthalate films each of 300 mm square and 75 μm thick by the use of a die coater and then dried in a nitrogen oven at 80° C. for 10 minutes, thereby obtaining supported-added film-shaped molds each having a thickness of a resin mold being 40 μm.

A double-sided copper-clad board was prepared which was a board with copper clad on both sides of a core board obtained by impregnating a glass cloth with a varnish containing a glass filler and a halogen-free epoxy resin and had with a thickness of 0.4 mm formed with first conductor layers 2 each having a wiring width and an interwire distance of 50 μm and a conductor thickness of 18 μm. This double-sided copper-clad board was immersed in a 5 wt % sulfuric acid aqueous solution at 25° C. for 1 minute and then washed with pure water, thereby obtaining an inner-layer board. The surface roughness Ra of the first conductor layers 2 was 70 nm. Then, a 0.1 wt % 2,4,6-trimercapto-S-triazine isopropyl alcohol solution was prepared. The foregoing core board was immersed in this solution at 25° C. for 1 minute and then dried in a nitrogen-substituted oven at 90° C. for 15 minutes, thereby forming primer layers on the inner-layer board.

Then, the previously obtained support-added film-shaped molds were overlaid on the inner-layer board such that the surfaces of the resin molds face inward. By the use of a vacuum laminating apparatus having upper and lower heat-resistant rubber press plates, the pressure was reduced to 200 Pa and the inner-layer board with the support-added film-shaped molds was heat-pressed at a temperature of 110° C. and a pressure of 1.0 MPa for 60 seconds as a first press. Then, by the use of a vacuum laminating apparatus having upper and lower heat-resistant rubber press plates covered with metal press plates, the pressure was reduced to 200 Pa and the inner-layer board with the support-added film-shaped molds was heat-pressed at a temperature of 140° C. and a pressure of 1.0 MPa for 60 seconds as a second press. Then, only the polyethylene naphthalate films were stripped, thereby obtaining resin layers on the inner-layer board.

Then, the inner-layer board formed with the resin layers was immersed in an aqueous solution, containing 1-(2-aminoethyl)-2-methylimidazole adjusted to 1.0 wt %, at 30° C. for 10 minutes, then immersed in water at 25° C. for 1 minute, and then the excessive solution was removed by an air knife. This was left standing at 60° C. for 30 minutes and at 170° C. for 60 minutes in a nitrogen oven, thereby obtaining a circuit board having first electrically insulating layers 3 formed on the inner-layer board.

At portions of the electrically insulating layers of the obtained circuit board, interlayer connection via holes each having a diameter of 30 μm were formed by the use of a UV-YAG laser.

The foregoing via hole-added circuit board was immersed in a permanganic acid treatment bath, containing DS250A (manufactured by Ebara-Udylite Co., Ltd.) adjusted to a concentration of 60 g/liter and DS150B (manufactured by Ebara-Udylite Co., Ltd.) adjusted to a concentration of 70 ml/liter, at 70° C. for 10 minutes and further washed with hot water in a hot water bath at 45° C. for 1 minute. Then, the circuit board was immersed in a water tank for 1 minute and further immersed in another water tank for 1 minute, thereby carrying out washing with water. Subsequently, the board was immersed in a neutralization reduction bath, containing DS350 (manufactured by Ebara-Udylite Co., Ltd.) adjusted to a concentration of 50 ml/liter and sulfuric acid adjusted to 50 ml/liter, at 45° C. for 5 minutes, thereby carrying out a neutralization reduction process.

After the neutralization reduction process, the circuit board having been subjected to washing with water in the same manner as described above was immersed in a catalyst bath, containing PC65H (manufactured by Ebara-Udylite Co., Ltd.) adjusted to a concentration of 250 ml/liter and SS400 (manufactured by Ebara-Udylite Co., Ltd.) adjusted to a concentration of 0.8 ml/liter, at 50° C. for 5 minutes. Then, after washing the circuit board with water in the same manner as described above, the circuit board was immersed in a catalyst activation bath, containing PCBA (manufactured by Ebara-Udylite Co., Ltd.) adjusted to 14 g/liter and PC66H (manufactured by Ebara-Udylite Co., Ltd.) adjusted to 10 ml/liter, at 35° C. for 5 minutes, thereby reducing the plating catalyst.

The circuit board thus obtained was immersed in an electroless copper plating bath, containing PB556MU (manufactured by Ebara-Udylite Co., Ltd.) adjusted to 20 ml/liter, PB556A (manufactured by Ebara-Udylite Co., Ltd.) adjusted to 60 ml/liter, PB566B (manufactured by Ebara-Udylite Co., Ltd.) adjusted to 60 ml/liter, and PB566C (manufactured by Ebara-Udylite Co., Ltd.) adjusted to 60 ml/liter, at 35° C. for 4.5 minutes while blowing air, thereby carrying out an electroless plating process. The circuit board formed with metal thin film layers by the electroless plating process was further washed with water in the same manner as described above. Then, the circuit board was immersed in an antirust solution, containing AT-21 (manufactured by Uyemura & Co., Ltd.) adjusted to 10 ml/liter, at room temperature for 1 minute, further washed with water in the same manner as described above, and then dried, thereby applying an antirust process to the circuit board.

The circuit board applied with the antirust process was heated at 170° C. for 30 minutes. Commercial photosensitive resist dry films were heat-pressed onto the surfaces of the circuit board after the heat treatment. Then, a mask having a pattern corresponding to a characteristic impedance evaluation pattern was brought into tight contact with each dry film, then exposed and developed, thereby obtaining a resist pattern. Then, the circuit board was immersed in a solution, containing sulfuric acid at 50 ml/liter, at 25° C. for 1 minute, thereby removing the antirust agent. Then, electrolytic copper plating was applied to portions where no resist was formed, thereby forming electrolytic copper plating films each having a thickness of 18 μm. Thereafter, the resist patterns on the board were removed using a stripping solution and etching was carried out by the use of a mixed solution of cupric chloride and hydrochloric acid, thereby forming second conductor layers 4 each composed of the metal thin film and the electrolytic copper plating film on the circuit board 1. In this circuit board, the surface roughness (i.e. the arithmetic average roughness) Ra of the first electrically insulating layers 3 at portions with no second conductor layer 4 was 100 nm.

Then, in the same manner as described above, the surface roughness Ra of the second conductor layers 4 was adjusted to 70 nm, then primer layers made of 2,4,6-trimercapto-s-triazine were formed on the surfaces, and then second electrically insulating layers 5 were formed on the primer layers, thereby obtaining a wiring pattern-added multilayered circuit board A with four layers on each of both sides. The evaluation results are shown in Table 1 below.

### EXAMPLE 2

A wiring pattern-added multilayered circuit board B with four layers on each of both sides was obtained in the same manner as in Example 1 except that the surfaces of the first electrically insulating layers 3 in Example 1 were immersed in the permanganic acid treatment bath for 30 minutes. The surface roughness Ra of the first conductor layers 2 and that of the first electrically insulating layers 3 measured in the processes for obtaining the subject board were 70 nm and 350 nm, respectively. The evaluation results are shown in Table 1 below.

### EXAMPLE 3

100 parts of the foregoing maleic acid modified hydrogenated polymer, 40 parts of bisphenol A bis(propylene glycol glycidyl ether)ether, 0.1 parts of 1-benzyl-2-phenylimidazole (curing accelerator), 5 parts of 2-[2-hydroxy-3,5-bis(α, α-dimethylbenzyl)phenyl]benzotriazole (laser processability improving agent), 1 part of tris(3,5-di-t-butyl-4-hydroxybenzyl)-isocyanurate, 10 parts of liquid polybutadiene (B-1000, Nippon Petrochemicals Company, Ltd.), and 156 parts of a ferrite material (Toda Kogyo Corporation) in the form of fine magnetic substance powder made of an insulator were dissolved in a mixed organic solvent composed of 222 parts of xylene and 555 parts of cyclopentanone, and uniformly dispersed/mixed by the planetary mixer, thereby obtaining a fine magnetic substance powder containing varnish.

A wiring pattern-added multilayered circuit board C with four layers on each of both sides was obtained in the same manner as in Example 1 except that the fine magnetic substance powder containing varnish was used. The surface roughness Ra of the first conductor layers 2 and that of the first electrically insulating layers 3 measured in the processes for obtaining the subject board were 70 nm and 100 nm, respectively. Further, the relative permittivity and the relative magnetic permeability of the first and second electrically insulating layers 3 and 5 were 2.7 and 2.7, respectively. The evaluation results are shown in Table 1.

### COMPARATIVE EXAMPLE 1

A wiring pattern-added multilayered circuit board D with four layers on each of both sides was obtained in the same manner as in the foregoing Example 1 except that the surfaces of the first conductor layers 2 in the foregoing Example 1 were subjected to microetching by contact with an organic acid. The surface roughness Ra of the first conductor layers 2 and the surface roughness Ra of the first electrically insulating layers 3 measured in the processes for obtaining the subject board were 1.5 μm and 100 nm, respectively. The evaluation results are shown in Table 1 below.

### COMPARATIVE EXAMPLE 2

A wiring pattern-added multilayered circuit board E with four layers on each of both sides was obtained in the same manner as in the foregoing Comparative Example 1 except that the surfaces of the first electrically insulating layers 3 in the foregoing Comparative Example 1 were immersed in the permanganic acid treatment bath for 60 minutes. The surface roughness Ra of the first conductor layers 2 and the surface roughness Ra of the first electrically insulating layers 3 measured in the processes for obtaining the subject board were 1.5 μm and 500 nm, respectively. The evaluation results are shown in Table 1 below.

### COMPARATIVE EXAMPLE 3

26.8 parts of n-butyl acrylate, 5.2 parts of styrene, and 26.8 parts of acrylic acid were polymerized in a 7:3 (weight ratio) mixed solvent of ethylmethylketone and ethanol in the presence of azobisisobutyronitrile, thereby obtaining an acrylic-based polymer. 0.23 parts of hydroquinone was added thereto and, while blowing a slight amount of air, 15 parts of N,N-dimethylbenzylamine and 147 parts of glycidyl methacrylate were added, then keeping it at a temperature of 77° C. for 10 hours, thereby obtaining a base polymer containing a carboxyl group with a weight average molecular weight of approximately 30000, an acid value of 225 mg/g, and an unsaturated group content of 0.9 mol %/Kg.

30 parts of the base polymer, 10 parts of ethylene oxide modified bisphenol A diacrylate (tradename: ARONIX M210 manufactured by Toagosei Co., Ltd.), 40 parts of brominated epoxy methacrylate, 7 parts of triaryl phosphate, and 2 parts of a thermal polymerization initiator were mixed together. 100 parts of a dispersion solution (solid matter: approximately 20%) obtained by dispersing acrylic particles (tradename: F-351 manufactured by Zeon Kasei Co., Ltd.) into methylethylketone were added to the mixture and mixed by the use of “Homodisper”, thereby obtaining a resin composition. Methylethylketone was added to this composition to adjust the viscosity at 25° C., measured by a BM-type viscometer, to approximately 700 cps and then filtration was carried out by the use of a Teflon (registered trademark) precision filter having a pore size of 50 μm, thereby obtaining a resin varnish.

A multilayered circuit board F was obtained in the same manner as in Comparative Example 2 except that this resin varnish was used instead of the varnish used in Comparative Example 2. The surface roughness Ra of the first conductor layers 2 and the surface roughness Ra of the first electrically insulating layers 3 measured in the processes for obtaining the subject board were 1.5 μm and 4.0 μm, respectively. The evaluation results are shown in Table 1.

TABLE 1

| Surface Roughness Ra | | | |
|---|---|---|---|
| First Conductor | First Electrically | Evaluation Item | |
| Layer | Insulating Layer | TDR | TDT |

| | | | | | | |
|---|---|---|---|---|---|---|
| Example 1 | 70 | nm | 100 | μm | ? | ? |
| Example 2 | 70 | nm | 350 | nm | ∘ | ∘ |
| Example 3 | 70 | nm | 100 | nm | ? | ? |
| Comparative | 1.5 | μm | 100 | nm | ? | ? |
| Example 1 | | | | | | |
| Comparative | 1.5 | μm | 0.5 | μm | x | x |
| Example 2 | | | | | | |
| Comparative | 1.5 | μm | 4 | μm | x | x |
| Example 3 | | | | | | |

As shown in Table 1 above, it has been found that the circuit boards according to Examples 1 to 3 of this invention are excellent in pulse reflection characteristics (TDR) and pulse transmission characteristics (TDT) as compared with the circuit boards according to Comparative Examples 1 to 3, respectively.

Further, it is understood from Example 3 that, by forming the first electrically insulating layer 3 or the second electrically insulating layer 5 of a material selected in consideration of its relative permittivity εr and its relative magnetic permeability μr in the foregoing Examples, the characteristic impedance can be increased to thereby enable reduction in crosstalk and radiation noise. That is, by forming at least part of the first or second electrically insulating layer 3 or 5 of a material that satisfies a relationship of εr≦μr, the crosstalk and the radiation noise can be reduced. Specifically, it is preferable that the first or second electrically insulating layer 3 or 5 contain a synthetic resin and a magnetic substance and the synthetic resin be formed of at least one resin selected from the group consisting of an epoxy resin, a phenolic resin, a polyimide resin, a polyester resin, a fluororesin, a modified polyphenyl ether resin, a bismaleid triazine resin, a modified polyphenylene oxide resin, a silicon resin, an acrylic resin, a benzocyclobutene resin, a polyethylene naphthalate resin, a cycloolefin resin, and a polyolefin resin.

### INDUSTRIAL APPLICABILITY

As described above, since crosstalk or radiation noise hardly enters, the circuit board and its manufacturing method according to this invention are optimum for an electronic device circuit board, an electronic device using such a circuit board, and the manufacture thereof.

1. A circuit board comprising a first conductor layer formed on a core and a first electrically insulating layer formed on said first conductor layer, wherein:
the surface roughness Ra of said first conductor layer is 0.1 nm or more and less than 100 nm; and
a first primer layer including a thiol compound (a) as a main material is formed between said first conductor layer and said first electrically insulating layer.

2. The circuit board according to claim 1, wherein the surface roughness Ra of said first electrically insulating layer is 0.1 nm or more and 400 nm or less.

3. The circuit board according to claim 2, further comprising:
a second conductor layer;
a second primer layer including a thiol compound (b) as a main material; and
a second electrically insulating layer,
wherein said the second conductor layer, said second primer layer, and said second electrically insulating layer are stacked on said first electrically insulating layer in this order.

4. The circuit board according to claim 3, wherein the surface roughness Ra of said second conductor layer is in the range from 0.1 nm to 1 μm.

5. The circuit board according to claim 3, wherein the surface roughness Ra of said second electrically insulating layer is 0.1 nm or more and 400 nm or less.

6. The circuit board according to claim 1, wherein said thiol compound (a) is a compound expressed by the following formula (1) or (2) or an alkali metal salt thereof, 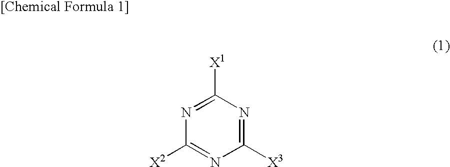
(in formula (1), X¹ to X³ are each independently —SH, —SR—NR′R″, or —SM (R, R′, and R″ are each independently linear or branched alkyl group having 1 to 5 carbons and M is an alkali metal) and at least one of these is —SH) 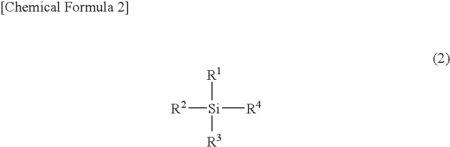
(in formula (2), R¹ to R⁴ are each independently linear or branched alkyl group having 1 to 5 carbons and having one or more —OR (R is a linear or branched alkyl group having 1 to 5 carbons) or —SH and at least one of these is a linear or branched alkyl group having 1 to 5 carbons and having one or more —SH).

7. The circuit board according to claim 3, wherein said thiol compound (b) is a compound expressed by the foregoing formula (1) or (2) or an alkali metal salt thereof.

8. The circuit board according to claim 6, wherein said thiol compound (a) is a compound expressed by said formula (1) and X¹ to X³ in said formula (1) are all —SH.

9. The circuit board according to claim 7, wherein said thiol compound (b) is a compound expressed by said formula (1) and X¹ to X³ in said formula (1) are all —SH.

10. The circuit board according to claim 1, wherein said first electrically insulating layer is formed by curing a curable resin composition containing an alicyclic olefin polymer.

11. The circuit board according to claim 3, wherein said second electrically insulating layer is formed by curing a curable resin composition containing an alicyclic olefin polymer.

12. The circuit board according to claim 1, wherein given that a relative permittivity and a relative magnetic permeability of said first electrically insulating layer are εr and μr, respectively, at least part of said first electrically insulating layer satisfies a relationship of εr≦μr.

13. The circuit board according to claim 3, wherein at least part of said second electrically insulating layer satisfies the relationship of εr≦μr when the relative permittivity and the relative magnetic permeability of said second electrically insulating layer are represented by εr and μr, respectively.

14. An electronic device comprising a circuit board, wherein:
said circuit board comprises a first conductor layer formed on a core and a first electrically insulating layer formed on said first conductor layer, the surface roughness Ra of said first conductor layer is 0.1 nm or more and less than 100 nm; and
a first primer layer including a thiol compound (a) as a main material is formed between said first conductor layer and said first electrically insulating layer.

15. A method of manufacturing a circuit board comprising the steps of:
forming a first conductor layer on a core;
then bringing the board surface formed with said first conductor layer into contact with a metal corrosive agent to form the first conductor layer having the surface roughness Ra of 0.1 nm or more and less than 100 nm;
then bringing a primer composition containing a thiol compound (a) into contact with the board surface formed with said first conductor layer to form a first primer layer;
then stacking on said first primer layer an uncured or semicured resin mold made of a curable resin composition; and
then curing said resin mold to form a first electrically insulating layer.

16. The method according to claim 15, further comrising the step of bringing the surface of said first electrically insulating layer into contact with an oxidizing compound to adjust the surface roughness Ra thereof to 0.1 nm or more and 400 nm or less.

17. The method according to claim 15, further comprising the steps of:
forming a second conductor layer on the first electrically insulating layer having the surface roughness of 0.1 nm or more and 400 nm or less,
then bringing a primer composition containing a thiol compound (b) into contact with a board surface formed with said second conductor layer to form a second primer layer; and
then stacking on said second primer layer a film-shaped molded article made of a curable resin composition; and
then curing said film-shaped molded article to form a second electrically insulating layer.

18. The circuit board manufacturing method according to claim 16, further comprising the steps of:
forming a second conductor layer on the first electrically insulating layer having the surface roughness of 0.1 nm or more and 400 nm or less;
then bringing a primer composition containing a thiol compound (b) into contact with a board surface formed with said second conductor layer to form a second primer layer; and
then stacking on said second primer layer a film-shaped molded article made of a curable resin composition; and
then curing said film-shaped molded article to form a second electrically insulating layer.
